(19) United States
(12) Patent Application Publication
(10) Pub. No.: US 2007/0259557 A1
(43) Pub. Date: Nov. 8, 2007

(54) Clamping assembly for a machine

(76) Inventor: Jung-Li Hung, Taichung Hsien (TW)

Correspondence Address: Thomas E. Sisson;Jackson Walker, LLP, Suite 2400, 112 E. Pecan, San Antonio, TX, 78205, US

(21) Appl. No.: 11/789,307

(22) Filed: Apr. 24, 2007

(30) Foreign Application Priority Data
May 2, 2006 (TW) 095207476

(51) Int. Cl. H01R 4/24

(52) U.S. Cl. 439/395

(57) ABSTRACT

A clamping assembly has a main body, a connecting sleeve and a clamping device. The main body has a connecting end and a clamping end. The connecting sleeve is slidably mounted in the main body. The clamping device is attached to the main body, is connected to the connecting sleeve and has a clamping base, a connecting base and a clamping head. The clamping base has a chamber and a conical recess defined in the clamping base at an end opposite to the main body. The connecting base is slidably mounted in the chamber and ha a connecting rod connected to the connecting sleeve. The clamping head is resilient, is slidably mounted in the conical recess in a non-rotatable manner, is connected to the connecting base and has conical outer surface and a holding hole. The conical outer surface corresponds to the conical recess in the clamping base.

### BACKGROUND OF THE INVENTION

1. Field of the Invention

The present invention relates to a clamping assembly, and more particularly to a clamping assembly for a machine adapted for holding a tubular member securely.

2. Description of Related Art

With reference to FIGS. 4 and 5, a conventional clamping assembly for a machine, such as a lathe, a miller or a driller comprises a main body (50), multiple claw bases (51) and a connecting sleeve (53). The claw bases (51) are slidably mounted in the main body (50) and are connected to connecting sleeve (53). Each claw base (51) has a claw (52) mounted on the base (51) and exposed from an end of the main body (50) to clamp a working member. The connecting sleeve (53) is connected to a driving lever and comprises an inner thread (530) and an annular flange (531). The inner thread (530) is defined in the connecting sleeve (53) to threadedly connect the driving lever. The annular flange (531) is formed around the outer periphery of the connecting sleeve (53) and is connected to the claw bases (51).

When the connecting sleeve (53) is moved away from the claw bases (51), the claw bases (51) with the claws (52) will be simultaneously moved toward the center of the main base (50) to clamp a working member securely.

However, the working member is always a cylindrical or tubular member and contacts with each claw (52) in a single line. To securely hold the cylindrical or tubular working member with the claws, the clamping force provided by the claws (52) and applied to the working member is huge. Therefore, the cylindrical or tubular working is easily damaged or deformed with the huge clamping force, specifically to a tubular working member with a thin thickness.

To overcome the shortcomings, the present invention tends to provide a clamping assembly to mitigate or obviate the aforementioned problems.

### SUMMARY OF THE INVENTION

The main objective of the invention is to provide a clamping assembly for a machine and that can hold a tubular working member securely but does not damage or deform the working member. The clamping assembly has a main body, a connecting sleeve and a clamping device. The main body has a connecting end, a clamping end and a central hole defined through the main body between the connecting end and the clamping end. The connecting sleeve is slidably mounted in the central hole in the main body through the connecting end. The clamping device is attached to the main body, is connected to the connecting sleeve and has a clamping base, a connecting base and a clamping head. The clamping base is attached securely to the clamping end of the main body and has a chamber defined in the clamping base and a conical recess defined in the clamping base at an end opposite to the clamping end of the main body. The connecting base is slidably mounted in the chamber in the clamping base and ha a connecting rod. The connecting rod is formed on and extends from the connecting base, extends out from the clamping base and is connected to the connecting sleeve. The clamping head is resilient, is slidably mounted in the conical recess in the clamping base in a non-rotatable manner, is connected to the connecting base and has conical outer surface and a holding hole. The conical outer surface corresponds to and matches with the conical recess in the clamping base. The holding hole is defined in the clamping head.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of a clamping assembly in accordance with the present invention;

FIG. 2 is a side view in partial section of the clamping assembly in FIG. 1;

FIG. 3 is an operational side view in partial section of the clamping assembly in FIG. 1;

FIG. 4 is a perspective view of a conventional clamping assembly in accordance with the prior art; and

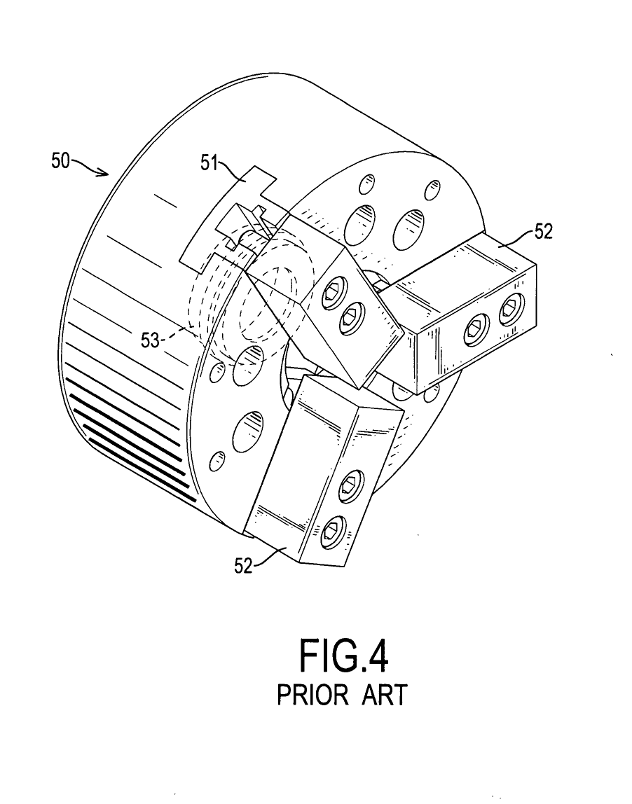

FIG. 5 is a cross sectional side view of a connecting sleeve of the conventional clamping assembly in FIG. 4.

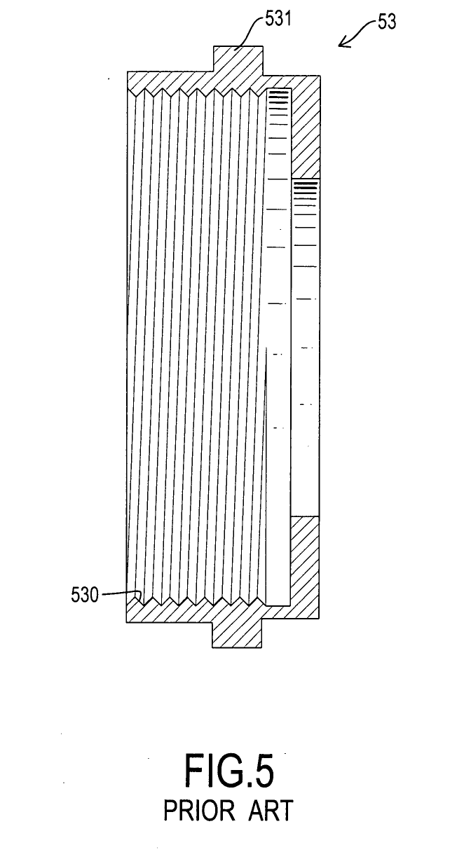

### DETAILED DESCRIPTION OF PREFERRED EMBODIMENT

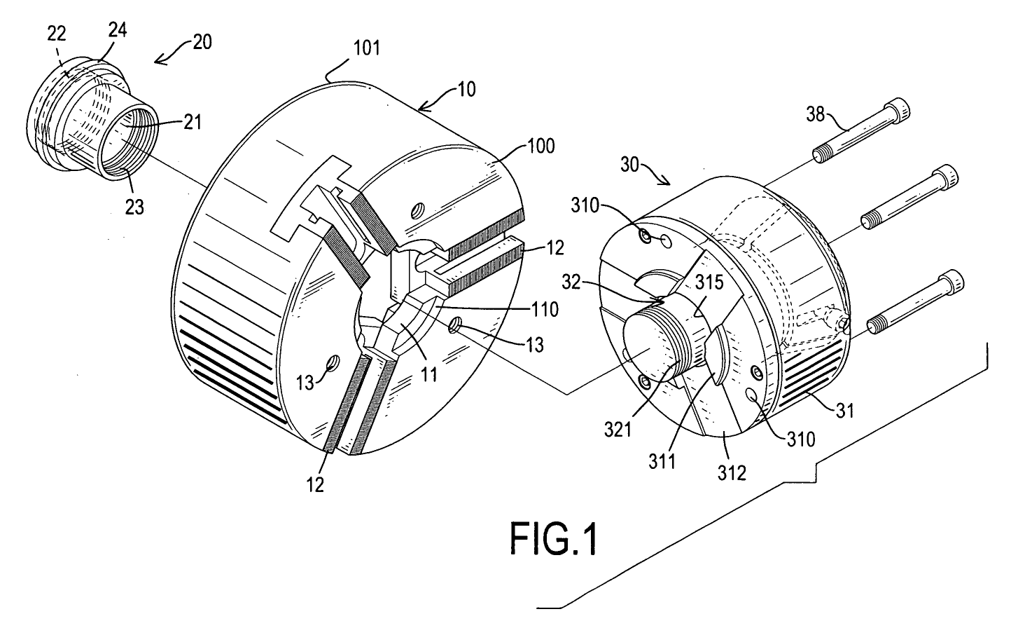

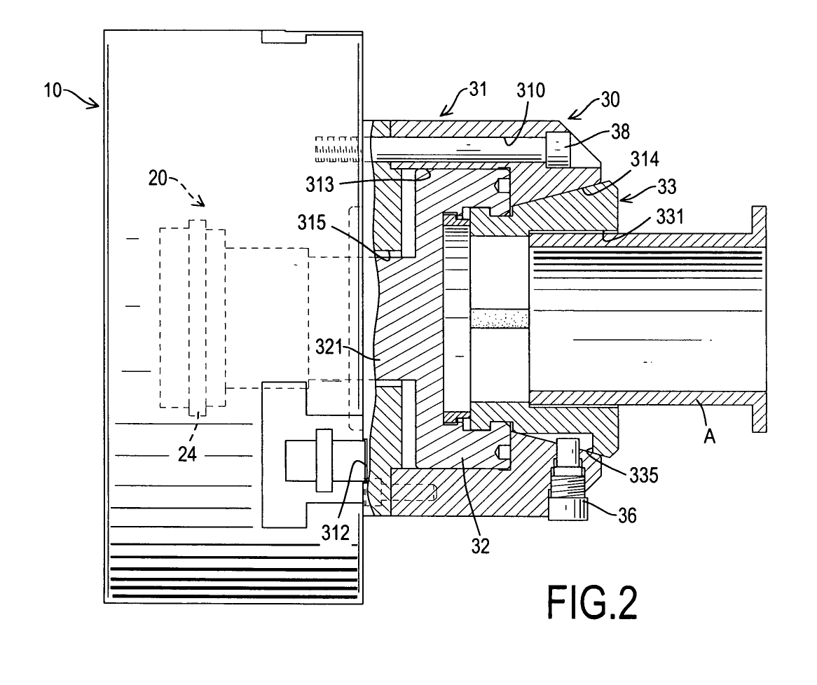

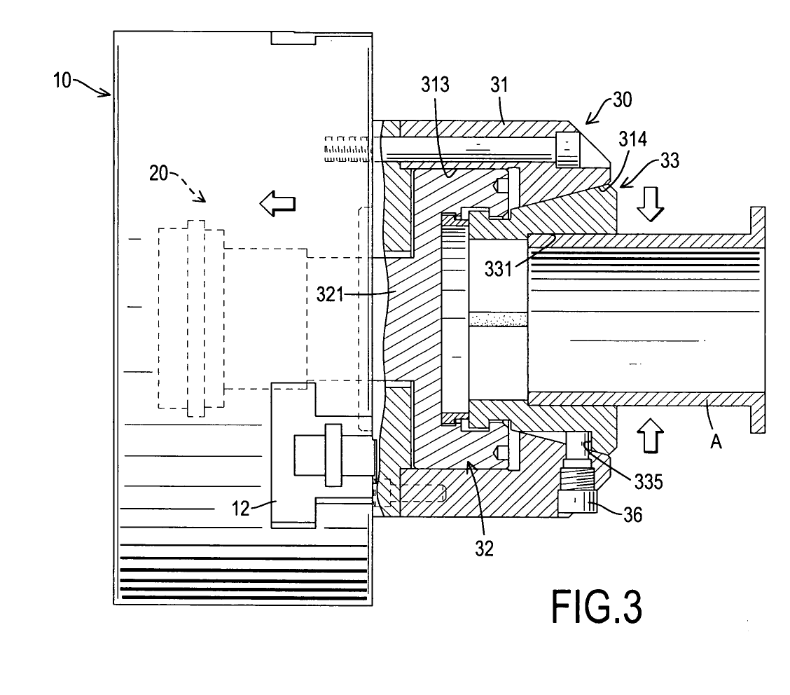

With reference to FIGS. 1 to 3, a clamping assembly for a machine in accordance with the present invention comprises a main body (10), a connecting sleeve (20) and a clamping device (30). The main body (10) is cylindrical and has a connecting end (101), a clamping end (100) and a center. A central hole (11) is defined through the center of the main body (10) between the connecting end (101) and the clamping end (100). An annular recess (110) is defined in the clamping end (100) and is defined around and communicates with the central hole (11). Multiple claw grooves are defined radially in the clamping end (100) and communicate with the central hole (11). Multiple claw bases (12) are slidably and respectively mounted in the claw grooves and extend toward the central hole (11). Multiple threaded holes (13) are defined in the clamping end (100).

The connecting sleeve (20) is mounted slidably in the central hole (11) through the connecting end (101), is connected to the claw bases (12) and comprises a first inner thread (22), a second inner thread (23) and an annular flange (24). The first inner thread (22) and the second inner thread (23) are formed respectively at two ends of the connecting sleeve (20). The first inner thread (22) is adapted to connect with a driving lever. The annular flange (24) is formed around the outer periphery of the connecting sleeve (20) near the end defining the first inner thread (22).

The clamping device (30) is attached to the clamping end (100) of the main body (10), is connected to the connecting sleeve (20) and comprises clamping base (31), a connecting base (32) and a clamping head (33). The clamping base (31) is securely attached to the clamping end (100) of the main body (10) and has multiple fastener holes (310) defined longitudinally through the clamping base (31) and aligned respectively with the threaded holes (13) in the main body (10). Multiple fasteners (38), such as screws extend respectively through the fastener holes (310) and are screwed respectively into the threaded holes (13) to securely attach the clamping base (31) to the main body (10). A central hole (315) is defined in the center of the clamping base (31) at an end corresponding to the clamping end (100) of the main body (10) and aligns with the central hole (11) in the main body (10). Multiple curved protrusions (311) formed on the end of the clamping base (31), are arranged around the central hole (315) and are held inside the annular recess (110) in the main body (10). Multiple claw channels (312) are defined in the clamping base (31) at the end with the central hole (315), communicate with the central hole (315) and correspond respectively to the claw grooves to partially hold the claw bases (12), respectively. A chamber (313) is define in the clamping base (31) and communicates with the central hole (315), and a conical recess (314) is defined in the clamping base (31) at an end opposite to the clamping end (100) of the main body (10) and communicates with the chamber (313).

The connecting base (32) is slidably mounted in the chamber (313) in the clamping base (31). The connecting base (32) comprises a connecting rod (321) formed on and extending from the connecting base (32), extending out from the clamping base (31) through the central hole (315) and extending into the central hole (11) in the main body (10). An outer thread is formed on the connecting rod (321) at an end extending out from the clamping base (31) and is screwed with the second inner thread (23) in the connecting sleeve (20).

The clamping head (33) is hollow and resilient, is slidably mounted in the conical recess (314) in a non-rotatable manner and is connected to the connecting base (32). The clamping head (33) has a conical outer surface corresponding to and matching with the conical recess (314) in the clamping base (31). A holding hole (331) is defined axially through the clamping head (33) to hold a working member (A) inside. In a preferred embodiment, the clamping head (33) has multiple gaps defined longitudinally through the clamping head (33) and filled with resilient materials. With the gaps with the resilient materials, the clamping head (33) is resilient and is compressible. To connect the clamping head (33) with the clamping base (31) in a slidable but non-rotatable manner, a guiding channel (335) is defined longitudinally in the outer surface of the clamping head (33). A holding fastener (36) is screwed into the clamping base (31) and extends into the guiding channel (335). With the engagement between the guiding channel (335) and holding fastener (36), the clamping head (33) is slidable but non-rotatable relative to the clamping base (31).

When the connecting sleeve (20) is pulled to move relative to the main body (10) inside the central hole (11), the connecting base (32) will be moved with the connecting sleeve (20) and relative to the chamber (313) in the clamping base (31). Consequently, the clamping head (33) is moved in the conical recess (314) in the clamping base (31). With the abutment between the conical recess (314) and the outer surface of the clamping head (33), the clamping head (33) is compressed to securely hold a working member (A) that is inserted into the holding hole (331) in the clamping head (33). Because the working member (A) contacts with the holding hole (331) at a large area, the pressure applied to the working member (A) is reduced. Accordingly, the working member (A) is not easily damaged or deformed even when the working member (A) is a hollow tubular member with a thin thickness. In addition, with the arrangements of the fasteners (36,38), the clamping base (31) and the clamping head (33) with the working member (A) are rotated with the main body (10) to allow the working member (A) to be cut or turned.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A clamping assembly for a machine comprising:
a main body having
a connecting end;
a clamping end; and
a central hole defined through the main body between the connecting end and the clamping end;
a connecting sleeve slidably mounted in the central hole in the main body through the connecting end; and
a clamping device attached to the main body, connected to the connecting sleeve and having
a clamping base attached securely to the clamping end of the main body and having
a chamber defined in the clamping base; and
a conical recess defined in the clamping base at an end opposite to the clamping end of the main body;
a connecting base slidably mounted in the chamber in the clamping base and having
a connecting rod formed on and extending from the connecting base, extending out from the clamping base and connected to the connecting sleeve; and
a clamping head being resilient, slidably mounted in the conical recess in the clamping base in a non-rotatable manner, connected to the connecting base and having
a conical outer surface corresponding to and matching with the conical recess in the clamping base; and
a holding hole defined in the clamping head.

2. The clamping assembly as claimed in claim 1, wherein
the connecting sleeve has an inner thread defined in one end of the connecting sleeve; and
the connecting rod has an outer thread screwed with the inner thread in the connecting sleeve.

3. The clamping assembly as claimed in claim 2, wherein the clamping head has a guiding channel defined longitudinally in the outer surface of the clamping head; and
a holding fastener is screwed into the clamping base and extends into the guiding channel.

4. The clamping assembly as claimed in claim 3, wherein the main body has multiple threaded holes defined in the clamping end;
the clamping base has multiple fastener holes defined longitudinally through the clamping base and aligning respectively with the threaded holes in the main body; and
multiple fasteners extend respectively through the fastener holes in the clamping base and are screwed respectively into the threaded holes in the main body.

5. The clamping assembly as claimed in claim 4, wherein the main body has an annular recess defined in the clamping end of the main body and around the central hole in the main body; and
the clamping base has multiple curved protrusions held inside the annular recess in the main body.

6. The clamping assembly as claimed in claim 1, wherein the clamping head has a guiding channel defined longitudinally in the outer surface of the clamping head; and
a holding fastener is screwed into the clamping base and extends into the guiding channel.

7. The clamping assembly as claimed in claim 1, wherein the main body has multiple threaded holes defined in the clamping end;
the clamping base has multiple fastener holes defined longitudinally through the clamping base and aligning respectively with the threaded holes in the main body; and
multiple fasteners extend respectively through the fastener holes in the clamping base and are screwed respectively into the threaded holes in the main body.

8. The clamping assembly as claimed in claim 1, wherein the main body has an annular recess defined in the clamping end of the main body and around the central hole in the main body; and
the clamping base has multiple curved protrusions held inside the annular recess in the main body.
